(19) United States
(12) Patent Application Publication
(10) Pub. No.: US 2026/0035552 A1
(43) Pub. Date: Feb. 5, 2026

(54) RUBBER COMPOSITION FOR RUBBER LAYER OF MULTILAYERED HOSE, MULTILAYERED HOSE, AND MULTILAYERED HOSE FOR MOTOR VEHICLE

(71) Applicant: Sumitomo Riko Company Limited, Aichi (JP)

(72) Inventors: Takahiro Morita, Aichi (JP); Motoki Hirado, Aichi (JP); Ryo Hirai, Aichi (JP); Masashi Noda, Aichi (JP)

(73) Assignee: Sumitomo Riko Company Limited, Aichi (JP)

(21) Appl. No.: 19/352,426

(22) Filed: Oct. 7, 2025

Related U.S. Application Data
(63) Continuation of application No. PCT/JP2024/033798, filed on Sep. 24, 2024.

(30) Foreign Application Priority Data
Sep. 26, 2023 (JP) 2023-161827

(51) Int. Cl. C08L 23/16; B32B 1/08; B32B 5/02; B32B 25/08; B32B 25/10; B32B 25/14; B32B 37/00; B32B 37/14; B32B 37/15; C08K 3/06; C08K 5/14; C08K 5/3415

(52) U.S. Cl. CPC C08L 23/16; B32B 1/08; B32B 5/024; B32B 25/08; B32B 25/10; B32B 25/14; B32B 37/144; B32B 37/153; C08K 3/06; C08K 5/14; C08K 5/3415; B32B 2037/0092; B32B 2250/03; B32B 2260/048; B32B 2262/0223; B32B 2262/0269; B32B 2262/0284; B32B 2305/188; B32B 2305/72; B32B 2307/70; B32B 2319/00; B32B 2329/04; B32B 2367/00; B32B 2377/00; B32B 2597/00

(57) ABSTRACT

Provided is a multilayered hose having excellent interlayer adhesion and excellent sealing properties. Also provided is a rubber composition for an inner-side rubber layer 1 and/or an outer-side rubber layer 3, the rubber composition comprising the following components (A) to (D): (A) an ethylene-propylene-diene terpolymer, (B) a tackifier including a constituent unit derived from an aromatic monomer, (C) a bismaleimide compound, and (D) a crosslinking agent.

### CROSS-REFERENCE TO RELATED APPLICATION

The present application is a continuation of PCT/JP2024/033798, filed on Sep. 24, 2024, and is related to and claims priority from Japanese Patent Application No. 2023-161827 filed on Sep. 26, 2023. The entire contents of the aforementioned application are hereby incorporated by reference herein.

### TECHNICAL FIELD

The disclosure relates to a multilayered hose including a multilayered structure that has a rubber layer, and specifically relates to a multilayered hose including a multilayered structure formed by laminating a rubber layer and a resin layer such as a reinforcement layer, which is an engine cooling system hose such as a radiator hose used for connection between an engine and a radiator in a motor vehicle or the like, and a heater hose used for connection between an engine and a heater core, a refrigerant transport hose for a cooler, a fuel cell vehicle hose such as a methanol fuel hose and a hydrogen fuel hose, and a multilayered hose for a motor vehicle such as a gasoline fuel hose.

### BACKGROUND TECHNOLOGY

Conventionally, for multilayered hoses used in vehicles such as motor vehicles, for example, engine cooling system hoses such as a radiator hose used for connection between an engine and a radiator, and a heater hose used for connection between an engine and a heater core, hoses with a 3-layer structure (inner-side rubber layer/reinforcement fiber layer/outer-side rubber layer) are used, in which a reinforcement fiber layer or the like is formed on the outer peripheral surface of an inner-side rubber layer, and an outer-side rubber layer is further formed on the outer peripheral surface thereof.

A hose with such a structure is manufactured, for example, by extrusion molding an inner-side rubber layer material to form an inner-side rubber layer, applying an adhesive to the outer peripheral surface of the inner-side rubber layer, then weaving reinforcement fibers such as nylon fiber (polyamide fiber) or aramid fiber on the outer peripheral surface to form a reinforcement fiber layer, extrusion molding an outer-side rubber layer material on the outer peripheral surface of the reinforcement fiber layer to form an outer-side rubber layer, and crosslinking these (see, for example, Patent Document 1 (International Publication No. 2012/133385), etc.), or, for example, by extrusion molding an inner-side rubber layer material to form an inner-side rubber layer, weaving reinforcement fibers such as nylon fiber (polyamide fiber) or aramid fiber on the outer peripheral surface of the inner-side rubber layer to form a reinforcement fiber layer, then applying an adhesive to the outer peripheral surface of the reinforcement fiber layer, extrusion molding an outer-side rubber layer material to form an outer-side rubber layer, and crosslinking these. In some cases, dipped fibers that have been dipped in an adhesive may also be used as reinforcement fibers.

However, according to the studies of the inventors of the disclosure, when performing the adhesive coating treatment or dipping treatment as described above, it is difficult to uniformly ensure good interlayer adhesion in the multilayered hose due to uneven coating or uneven impregnation, which for example leads to a problem that high-level sealing properties required for motor vehicle hoses, etc. cannot be guaranteed.

In addition, since adhesives are typically composed of adhesive components dissolved in solvents belonging to Class 4 dangerous substances such as toluene, xylene, and methyl ethyl ketone, volatile organic compounds (VOC) are generated in the manufacturing process, which leads to a problem of deterioration of the global environment.

The disclosure provides a multilayered hose that has excellent interlayer adhesion and excellent sealing properties without using an adhesive.

The inventors of the disclosure have conducted intensive research to solve the above problems. In the course of this research, the inventors have found that, by using a rubber composition including (A) an ethylene-propylene-diene terpolymer, (B) a tackifier including a constituent unit derived from an aromatic monomer, (C) a bismaleimide compound, and (D) a crosslinking agent as the rubber composition constituting a rubber layer of a multilayered hose, the interlayer adhesion between the rubber layer and the adherend layer improves, and as a result, a multilayered hose with excellent sealing properties can be provided.

In other words, in the course of researching for a multilayered hose with excellent interlayer adhesion, the inventors of the disclosure considered incorporating various tackifiers, but only incorporating various tackifiers into the rubber composition for a rubber layer made it difficult to sufficiently enhance the interlayer adhesion. As a result of further intensive research focusing on the affinity between the rubber component and other formulation components, and the interaction between various formulation components, along with the examination of tackifiers, the inventors of the disclosure have found that the interlayer adhesion in the multilayered hose is enhanced by using an ethylene-propylene-diene terpolymer among various rubbers, and using in combination a specific tackifier and a bismaleimide compound among various compounding agents, thus arriving at the disclosure.

### SUMMARY

That is, the gist of the disclosure lies in the following [1] to [12].

[1]

A rubber composition for a rubber layer of a multilayered hose, the rubber composition including the following components (A) to (D):
(A) an ethylene-propylene-diene terpolymer,
(B) a tackifier including a constituent unit derived from an aromatic monomer,
(C) a bismaleimide compound, and
(D) a crosslinking agent.
   [2]

The rubber composition for the rubber layer according to [1], in which the component (B) is a tackifier including 20 mass % or more of a constituent unit derived from an aromatic monomer.

[3]

The rubber composition for the rubber layer according to [1] or [2], in which the component (B) and the component (C) have a total content (B+C) of 2.5 parts by mass to 20 parts by mass with respect to 100 parts by mass of the component (A).

[4]

The rubber composition for the rubber layer according to any one of [1] to [3], in which the component (B) and the component (C) have a mass ratio (B/C) of 0.25 to 1.5.

[5]

The rubber composition for the rubber layer according to any one of [1] to [4], in which the component (C) is an aromatic bismaleimide compound.

[6]

The rubber composition for the rubber layer according to any one of [1] to [5], in which the component (B) is a tackifier further including a constituent unit derived from an aliphatic monomer.

[7]

The rubber composition for the rubber layer according to any one of [1] to [6], in which the multilayered hose is a multilayered hose including a multilayered structure formed by laminating a rubber layer and a resin layer.

[8]

The rubber composition for the rubber layer according to [7], in which the resin layer is a reinforcement fiber layer including a reinforcement fiber including at least one selected from a group consisting of polyamide fiber, polyethylene terephthalate fiber, and polyvinyl alcohol fiber.

[9]

A multilayered hose, including a multilayered structure formed by laminating a rubber layer including a crosslinked product of the rubber composition for the rubber layer according to any one of [1] to [6], and a resin layer.

[10]

The multilayered hose according to [9], in which the resin layer is a reinforcement fiber layer.

[11]

A multilayered hose for a motor vehicle, the multilayered hose including a multilayered structure formed by laminating, in this order, a first rubber layer including a crosslinked product of the rubber composition for the rubber layer according to any one of [1] to [6], a reinforcement fiber layer, and a second rubber layer including a crosslinked product of a rubber composition for a rubber layer including the component (A) and the component (D).

That is, a multilayered hose for a motor vehicle, including a multilayered structure formed by laminating, in this order, a first rubber layer including a crosslinked product of a rubber composition for a rubber layer containing the following components (A) to (D), and a second rubber layer including a crosslinked product of a rubber composition for a rubber layer containing the following component (A) and component (D):
(A) an ethylene-propylene-diene terpolymer,
(B) a tackifier including a constituent unit derived from an aromatic monomer,
(C) a bismaleimide compound, and
(D) a crosslinking agent.
   [12]

The multilayered hose for the motor vehicle according to [11], in which the second rubber layer is a rubber layer including a crosslinked product of a rubber composition for a rubber layer further including the component (B) and/or the component (C).

According to the disclosure, it is possible to provide a multilayered hose that has excellent interlayer adhesion and excellent sealing properties without using any particular adhesive.

In addition, according to an embodiment of the disclosure, it is possible to reduce volatile organic compounds (VOC), and contribute to the preservation of the global environment. Furthermore, according to an embodiment of the disclosure, since it is possible to reduce processes such as the adhesive coating process in the manufacturing processes of a multilayer hose, it is very advantageous in terms of manufacturing cost.

### BRIEF DESCRIPTION OF THE DRAWINGS

FIG. 1 is a perspective view showing an example of the hose of the disclosure.

FIG. 2 is a view for illustrating the test method shown in this specification.

### DESCRIPTION OF THE EMBODIMENTS

Next, embodiments of the disclosure will be described in detail.

In this specification, “main component” means a component that has a significant influence on the properties of the material, and the content of the component is, unless otherwise specified, 50 mass % or more of the entire material, preferably 60 mass % to 100 mass %, 70 mass % to 100 mass %, 80 mass % to 100 mass %, 90 mass % to 100 mass %, etc.

Further, in this specification, “X and/or Y (X and Y are any components)” means at least one of X and Y, and means three possibilities: X only, Y only, and both X and Y

### <<Rubber Composition for Rubber Layer>>

A rubber composition for a rubber layer according to an embodiment of the disclosure (hereinafter, may be referred to as “the rubber composition”) is characterized by including components (A) to (D):
(A) an ethylene-propylene-diene terpolymer,
(B) a tackifier including a constituent unit derived from an aromatic monomer,
(C) a bismaleimide compound, and
(D) a crosslinking agent.

The reason why high interlayer adhesion is obtained by a multilayered hose using the rubber composition including all components (A) to (D) is not necessarily clear, but it is presumed that by combining (B) a tackifier including a constituent unit derived from an aromatic monomer and (C) a bismaleimide compound, the affinity for (A) an ethylene-propylene-diene terpolymer decreases, and migration to the rubber layer surface is promoted, which consequently contributes to the formation of a diffusion layer, strengthens the unification between layers, and increases the interlayer adhesion force.

Specifically, for example, in a multilayered hose including a multilayered structure formed by laminating a rubber layer using the rubber composition and a reinforcement fiber layer, it is presumed that component (C) and component (B) are attracted and mixed by interaction, and migration to the interface is promoted, and together with the migration of component (D) to the interface, impregnation into the reinforcement fiber layer is promoted, which as a result causes these components to form a strong crosslinked structure, strengthens the unification between layers, and increases the interlayer adhesion force.

By using the rubber composition, it is possible to provide a multilayered hose that has high interlayer adhesion and excellent sealing properties without using any particular adhesive, which makes it possible to, for example, reduce volatile organic compounds (VOC) and contribute to the preservation of the global environment. Furthermore, since it is possible to reduce processes such as the adhesive coating process and dipping treatment process in the manufacturing processes of a multilayer hose, the manufacturing cost can be reduced.

The inventors of the disclosure have also found in the course of research that by using the rubber composition, it is possible to highly achieve both interlayer adhesion and compression set property in a multilayered hose. That is, in the course of researching how to improve interlayer adhesion in a multilayered hose, the inventors examined how to highly achieve both interlayer adhesion and compression set property, which is one of the important properties for multilayered hoses, but found it difficult to sufficiently enhance both interlayer adhesion and compression set property. As a result of further intensive research focusing on the affinity between the rubber component and other formulation components, and the interaction between various formulation components, along with the examination of tackifiers, the inventors of the disclosure have also found that by using the rubber composition, both interlayer adhesion and compression set property in a multilayered hose can be achieved highly. The rubber composition is very useful in achieving both interlayer adhesion and compression set property.

The embodiments of the disclosure will be described in more detail hereinafter.

### [(A) Ethylene-Propylene-Diene Terpolymer (EPDM)]

Component (A) used in the rubber composition is obtained by copolymerizing ethylene-propylene rubber (EPM), which is a copolymer of ethylene and propylene, with a diene-based monomer as a third component (hereinafter, may be abbreviated as “EPDM”). Component (A) may be used alone or in combination of two or more kinds.

As the diene-based monomer (third component) included in component (A), although not particularly limited, a diene-based monomer having 5 to 20 carbon atoms is preferred. Specifically, 1,4-pentadiene, 1,4-hexadiene, 1,5-hexadiene, 2,5-dimethyl-1,5-hexadiene, 1,4-octadiene, 1,4-cyclohexadiene, cyclooctadiene, dicyclopentadiene (DCP), 5-ethylidene-2-norbornene (ENB), 5-butylidene-2-norbornene, etc. can be mentioned. These may be used alone or in combination of two or more kinds. Among these, dicyclopentadiene (DCP) and 5-ethylidene-2-norbornene (ENB) are preferred.

The ethylene content of component (A) is not particularly limited, but from the viewpoint of remarkably exhibiting the effects of the disclosure, 48 mass % to 70 mass % is preferred, and 50 mass % to 60 mass % is more preferred.

In addition, the propylene content of component (A) is not particularly limited, but from the viewpoint of remarkably exhibiting the effects of the disclosure, 22 mass % to 46 mass % is preferred, and 30 mass % to 44 mass % is more preferred.

Further, the diene-based monomer content of component (A) is not particularly limited, but 3 mass % to 11 mass % is preferred, and 3.5 mass % to 6 mass % is more preferred.

Additionally, the iodine value of component (A) is not particularly limited, but from the viewpoint of remarkably exhibiting the effects of the disclosure, 6 to 30 is preferred, and 10 to 24 is more preferred.

The content of component (A) is not particularly limited, but is normally 20 mass % or more with respect to the rubber composition (100 mass %), preferably 25 mass % or more, and more preferably 28 mass % to 60 mass %.

### [(B) Tackifier]

In the rubber composition, it is important to use a tackifier that includes a constituent unit derived from an aromatic monomer among various tackifiers. That is, as component (B), for example, addition polymers of aromatic monomers having ethylenic carbon-carbon double bonds such as indene, vinyl toluene, styrene, α-methylstyrene, and isopropenyl can be mentioned. Component (B) may be a homopolymer of the above monomers, a copolymer composed of two or more kinds of monomers appropriately combined from the above monomers, or may be copolymerized with components other than aromatic monomers, for example, aliphatic monomers such as isoprene, 1,3-pentadiene, and 2-methyl-2-butene.

Component (B) may also be modified with phenolic compounds, maleic anhydride, acrylic acid, methacrylic acid, etc. Component (B) may be used alone or in combination of two or more kinds.

Among component (B), from the viewpoint of remarkably exhibiting the effects of the disclosure, hydrocarbon-based tackifier resin including a constituent unit derived from an aromatic monomer is preferred. As the above hydrocarbon-based tackifier resin, for example, aromatic (C9-based) petroleum resin, aliphatic/aromatic copolymer-based (C5/C9-based) petroleum resin, hydrogenated products thereof, various modified products thereof (for example, maleic anhydride modified products), coumarone-based resin, etc. can be mentioned.

As the aromatic (C9-based) petroleum resin, although not particularly limited, aromatic (C9-based) petroleum resin composed of one or more kinds selected from the group consisting of constituent units derived from indene, styrene, and vinyl toluene is preferred, and more preferably, the aromatic (C9-based) petroleum resin is composed of two or three kinds selected from the group consisting of constituent units derived from indene, styrene, and vinyl toluene. In addition, as the aliphatic/aromatic copolymer-based (C5/C9-based) petroleum resin, although not particularly limited, aliphatic/aromatic copolymer-based (C5/C9-based) petroleum resin composed of one or more kinds selected from the group consisting of indene, styrene, and vinyl toluene, and constituent units derived from isoprene and/or piperylene is preferred. Further, as the coumarone-based resin, although not particularly limited, coumarone-based resin including constituent units derived from coumarone, and further composed of one or more kinds selected from the group consisting of constituent units derived from indene, styrene, and vinyl toluene is preferred.

In addition, as component (B), alkylphenol resin, terpene phenol resin, rosin phenol resin, styrene resin, etc. can be mentioned.

The alkylphenol resin is not particularly limited as long as the alkylphenol resin is used as a tackifier, and is resin obtained from alkylphenols and formaldehyde. For example, condensation polymers of various alkylphenols such as o-cresol, m-cresol, p-cresol, ethylphenol, iso-propylphenol, xylenol, 3,5-xylenol, butylphenol, p-t-butylphenol, nonylphenol, etc. with formaldehyde can be mentioned.

The terpene phenol resin is not particularly limited as long as the terpene phenol resin is used as a tackifier, and includes, for example, both copolymers of terpenes and phenolic compounds (terpene-phenol copolymer resin) and phenol-modified products of homopolymers or copolymers of terpenes (phenol-modified terpene resin). As the terpenes constituting the terpene phenol resin, for example, monoterpenes such as α-pinene, β-pinene, limonene (including d-form, 1-form, and d/1-form (dipentene)), etc. can be mentioned.

The rosin phenol resin is not particularly limited as long as the rosin phenol resin is used as a tackifier, and includes rosin phenol resin obtained by addition reaction of phenolic compounds to natural rosin, rosin derivatives, etc., and so-called rosin-modified phenol resin obtained by reacting resole-type phenol resin with rosin-based resin. The rosin phenol resin may be used as metal salt of rosin phenol resin, or may be esterified products obtained by reacting rosin-based resin with polyhydric alcohols.

The styrene resin is not particularly limited as long as the styrene resin is used as a tackifier, and includes styrene resin having a homopolymer of styrene as the main component, styrene resin having a homopolymer of α-methylstyrene as the main component, styrene resin having a homopolymer of vinyl toluene as the main component, styrene resin having a copolymer including two or more kinds of styrene, α-methylstyrene, and vinyl toluene in the monomer composition as the main component, etc.

From the viewpoint of further improving interlayer adhesion, as component (B), a tackifier in which the content of the constituent unit derived from an aromatic monomer is 20 mass % or more with respect to the total constituent units of component (B) is preferred. From the same viewpoint, the content of the constituent unit derived from an aromatic monomer is more preferably 35 mass % or more, even more preferably 40 mass % or more, particularly preferably 50 mass % or more, and even particularly preferably 60 mass % to 100 mass %.

In the case where component (B) includes constituent units other than the constituent unit derived from an aromatic monomer (for example, in the case where component (B) includes constituent units derived from an aliphatic monomer), the content thereof is preferably 80 mass % or less, more preferably 65 mass % or less, even more preferably 55 mass % or less, particularly preferably 45 mass % or less, and even particularly preferably 40 mass % or less with respect to the total constituent units of component (B).

The softening point of component (B) is not particularly limited, but for example, is preferably 50° C. to 200° C., more preferably 60° C. to 150° C., and even more preferably 70° C. to 120° C. The softening point is measured by the ring and ball method in accordance with JIS K2207.

The content of component (B) is not particularly limited, but from the viewpoint of remarkably exhibiting the effects of the disclosure, the content of component (B) is preferably 1.25 parts by mass to 10 parts by mass, more preferably 2.5 parts by mass to 8 parts by mass, and even more preferably 3 parts by mass to 7 parts by mass with respect to 100 parts by mass of component (A).

### [(C) Bismaleimide Compound]

Component (C) used in the rubber composition includes compounds having two maleimide groups in the molecule, and aromatic bismaleimide compounds, aliphatic bismaleimide compounds, etc. can be mentioned. These may be used alone or in combination of two or more kinds.

Aromatic bismaleimide compounds are compounds that include a bismaleimide structure and a structure having an aromatic ring, and as the structure having an aromatic ring, for example, aryl groups or arylene groups having 6 to 30 carbon atoms can be mentioned. The aryl groups or arylene groups may have substituents. As the structure having an aromatic ring, for example, phenylene group, methylphenylene group, ethylphenylene group, propylphenylene group, butylphenylene group, dimethylphenylene group, diethylphenylene group, dipropylphenylene group, trimethylphenylene group, tetramethylphenylene group, dibutylphenylene group, naphthylene group, biphenylene group, fluorenylene group, phenanthrenylene group, anthraquinolylene group, etc. can be mentioned. Among these, phenylene group is preferred.

As specific examples of the aromatic bismaleimide compounds, for example, N,N′-(1,3-phenylene)bismaleimide, N,N′-(4-methyl-1,3-phenylene)bismaleimide, N,N′-(1,4-phenylene)bismaleimide, N,N′-(1,2-phenylene)bismaleimide, N,N′-(1,5-naphthylene)bismaleimide, N,N′-(4-chloro-1,3-phenylene)bismaleimide, N,N′-(methylene-di-p-phenylene)bismaleimide, N,N′-(4,4′-biphenylene)bismaleimide, N,N′-(sulfonyl-di-p-phenylene)bismaleimide, N,N′-(oxydi-p-phenylene)bismaleimide, N,N′-(3,3′-dimethyl-4,4′-biphenylene)bismaleimide, N,N′-(benzylidene-di-p-phenylene)bismaleimide, N,N′-[methylene bis(3-chloro-4-phenylene)]bismaleimide, N,N′-[methylene bis(3-methyl-4-phenylene)]bismaleimide, N,N′-[methylene bis(3-methoxy-4-phenylene)]bismaleimide, N,N′-(thio-di-p-phenylene)bismaleimide, N,N′-3,3′-benzophenone bismaleimide, N,N′-[methylene bis(3-methyl-5-ethyl-4-phenylene)]bismaleimide, N,N′-[tetramethylene bis(oxy-p-phenylene)]bismaleimide, 2,2-bis[4-(4-maleimidophenoxy)phenyl]propane, bis[4-(4-maleimidophenoxy)phenyl)]sulfone, 1,4-phenylene bis(4-maleimidophenoxy), bis[3-(4-maleimidophenoxy)phenyl]sulfone, bis[4-(3-maleimidophenoxy)phenyl]ketone, 1,3-phenylene bis(4-maleimidophenoxy), bis[4-(4-maleimidophenylthio)phenyl]ether, etc. can be mentioned. Among these, N,N′-(1,3-phenylene)bismaleimide is suitable.

As the aliphatic bismaleimide compounds, for example, N,N′-(2,2,4-trimethylhexamethylene)bismaleimide, N,N′-decamethylenebismaleimide, N,N′-octamethylenebismaleimide, N,N′-heptamethylenebismaleimide, N,N′-hexamethylenebismaleimide, N,N′-pentamethylenebismaleimide, N,N′-tetramethylenebismaleimide, N,N′-trimethylenebismaleimide, N,N′-ethylenebismaleimide, N,N′-(oxydimethylene)bismaleimide, 1,13-bismaleimide-4,7,10-trioxatridecane, 1,11-bismaleimide-3,6,9-trioxaundecane, etc. can be mentioned.

Among these components (C), from the viewpoint of remarkably exhibiting the effects of the disclosure, aromatic bismaleimide compounds are preferred. By using aromatic bismaleimide compounds as component (C), it is presumed that the affinity for component (A) decreases, migration to the interface is further promoted, and as a result, higher interlayer adhesion is obtained.

The content of component (C) is not particularly limited, but from the viewpoint of remarkably exhibiting the effects of the disclosure, the content of component (C) is preferably 1.25 parts by mass to 10 parts by mass, more preferably 2.5 parts by mass to 8 parts by mass, and even more preferably 4 parts by mass to 7 parts by mass with respect to 100 parts by mass of component (A).

The mass ratio (B/C) of component (B) to component (C) is not particularly limited, but from the viewpoint of achieving both interlayer adhesion and compression set property, 0.25 to 1.5 is preferred. In the case where the mass ratio is outside the above range, there tends to be difficulty in achieving both interlayer adhesion and compression set property.

The above mass ratio (B/C) can be appropriately set within the above range and is not particularly limited, but from the viewpoint of achieving both interlayer adhesion and compression set property, the mass ratio may be, for example, 0.4 to 1.3, 0.5 to 1.2, 0.7 to 1.1, etc.

The total content (B+C) of component (C) and component (B) is not particularly limited, but from the viewpoint of achieving both interlayer adhesion and compression set property, the total content is preferably 2.5 parts by mass to 20 parts by mass, more preferably 4.5 parts by mass to 14 parts by mass, and even more preferably 5 parts by mass to 14 parts by mass with respect to 100 parts by mass of component (A). In the case where the total content is outside the above range, there tends to be difficulty in achieving both interlayer adhesion and compression set property.

The above total content (B+C) can be appropriately set within the above range and is not particularly limited, but from the viewpoint of achieving both interlayer adhesion and compression set property, the total content may be, for example, 6 parts by mass to 12 parts by mass, etc.

### [(D) Crosslinking Agent]

As component (D), a sulfur-based crosslinking agent and a peroxide-based crosslinking agent can be mentioned. These can be used alone or in combination of two or more kinds.

As the sulfur-based crosslinking agent, for example, powdered sulfur, precipitated sulfur, colloidal sulfur, surface-treated sulfur, insoluble sulfur, etc. can be mentioned.

As the peroxide-based crosslinking agent, for example, 2,4-dichlorobenzoyl peroxide, benzoyl peroxide, 1,1-di-t-butylperoxy-3,3,5-trimethylcyclohexane, 2,5-dimethyl-2,5-dibenzoylperoxyhexane, n-butyl-4,4′-di-t-butylperoxy valerate, dicumyl peroxide, t-butylperoxy benzoate, di-t-butylperoxy-diisopropylbenzene, t-butylcumyl peroxide, 2,5-dimethyl-2,5-di-t-butylperoxy hexane, di-t-butyl peroxide, 2,5-dimethyl-2,5-di-t-butylperoxy hexyne-3, 1,3-bis-(t-butylperoxy-isopropyl)benzene, etc. can be mentioned.

In the case of using a sulfur-based crosslinking agent as component (D), the content of the sulfur-based crosslinking agent is, from the viewpoint of remarkably exhibiting the effects of the disclosure, preferably 0.5 parts by mass to 15 parts by mass, and particularly preferably 1 part by mass to 5 parts by mass with respect to 100 parts by mass of component (A).

In the case of using a peroxide-based crosslinking agent as component (D), the content of the peroxide-based crosslinking agent is, from the viewpoint of remarkably exhibiting the effects of the disclosure, preferably 0.5 parts by mass to 30 parts by mass, more preferably 1 part by mass to 20 parts by mass, and even more preferably 1.5 parts by mass to 10 parts by mass with respect to 100 parts by mass of component (A).

### [Other Components]

In addition to the above components (A) to (D), the rubber composition can be appropriately compounded as needed with components used in rubber compositions, such as crosslinking accelerator, filler, plasticizer, crosslinking aid, anti-aging agent, and processing aid, although not particularly limited.

As the crosslinking accelerator, although not particularly limited, for example, thiuram-based crosslinking accelerators such as tetramethylthiuram disulfide (TMTD), tetraethylthiuram disulfide (TETD), tetrabutylthiuram disulfide (TBTD), tetrakis(2-ethylhexyl)thiuram disulfide (TOT), and tetrabenzylthiuram disulfide (TBzTD); sulfenamide-based crosslinking accelerators such as N-oxydiethylene-2-benzothiazolylsulfenamide (NOBS), N-cyclohexyl-2-benzothiazolylsulfenamide (CBS), N-t-butyl-2-benzothiazolylsulfenamide (BBS), and N,N′-dicyclohexyl-2-benzothiazolylsulfenamide; thiazole-based crosslinking accelerators such as dibenzothiadyl disulfide (MBTS), 2-mercaptobenzothiazole (MBT), 2-mercaptobenzothiazole sodium salt (NaMBT), and 2-mercaptobenzothiazole zinc salt (ZnMBT); dithio acid salt-based crosslinking accelerators such as zinc dibutyldithiocarbamate (ZnBDC); sulfur chloride, sulfur disulfide, etc. can be mentioned. These may be used alone or in combination of two or more kinds.

The content of the crosslinking accelerator, although not particularly limited, is preferably 0.1 parts by mass to 10 parts by mass, more preferably 0.5 parts by mass to 8 parts by mass, and even more preferably 1 part by mass to 5 parts by mass with respect to 100 parts by mass of component (A).

As the filler, although not particularly limited, for example, carbon black, talc, mica, clay, calcium carbonate, etc. can be mentioned. These may be used alone or in combination of two or more kinds.

As the carbon black, although not particularly limited, for example, various grades of carbon black such as SAF grade, ISAF grade, HAF grade, MAF grade, FEF grade, GPF grade, SRF grade, FT grade, and MT grade can be mentioned.

The content of the filler, although not particularly limited, is preferably 20 parts by mass to 180 parts by mass, and more preferably 50 parts by mass to 160 parts by mass with respect to 100 parts by mass of component (A).

As the plasticizer, although not particularly limited, for example, aromatic oil, ether-ester-based plasticizer, process oil, etc. can be mentioned. These may be used alone or in combination of two or more kinds.

As the aromatic oil, for example, Diana Process AC-12, Diana Process AC-460, Diana Process AH-16 (all manufactured by Idemitsu Showa Shell), JSO Aroma 790 (manufactured by Japan Sun Oil), Aromax 1, Aromax 3 (both manufactured by Fuji Kosan), etc. can be mentioned. In addition, as the ether-ester-based plasticizer, plasticizers having both ether bonds and ester bonds in one molecule, specifically, adipic acid ether-ester-based plasticizers such as bis[2-(2-butoxyethoxy)ethyl]adipate, etc. can be mentioned. Further, as the process oil, for example, naphthenic oil, paraffinic oil, etc. can be mentioned.

The content of the plasticizer, although not particularly limited, is preferably 5 parts by mass to 100 parts by mass, and more preferably 20 parts by mass to 80 parts by mass with respect to 100 parts by mass of component (A).

As the crosslinking aid, although not particularly limited, for example, zinc oxide, zinc white (ZnO), stearic acid, magnesium oxide, etc. can be mentioned. These may be used alone or in combination of two or more kinds.

As the zinc oxide, for example, zinc oxide type 1, zinc oxide type 2, zinc oxide type 3, fine zinc oxide, etc. can be mentioned.

The content of the crosslinking aid, although not particularly limited, is preferably 1 part by mass to 25 parts by mass, and more preferably 3 parts by mass to 10 parts by mass with respect to 100 parts by mass of component (A).

### <<Multilayered Hose>>

The above rubber composition is used as a material for a rubber layer that constitutes a multilayered hose. The multilayered hose includes, for example, a multilayered structure formed by laminating a rubber layer composed of a crosslinked product of the rubber composition and a resin layer that serves as an adherend to the rubber layer.

As the resin constituting the main component of the resin layer, for example, one or more kinds selected from the group consisting of polyester such as polyethylene terephthalate, polyvinyl alcohol, aramid (aromatic polyamide), polyamide such as polyamide 6 and polyamide 66, etc. can be mentioned.

The resin layer is not particularly limited as long as the resin layer performs specific functions such as reinforcement function or permeation resistance function, but from the viewpoint of remarkably exhibiting the effects of the disclosure, the resin layer is preferably a reinforcement layer, and more preferably a reinforcement fiber layer made of resin reinforcement fibers.

As the reinforcement fibers constituting the reinforcement fiber layer, for example, polyester fibers such as polyethylene terephthalate fibers, polyvinyl alcohol fibers, aramid (aromatic polyamide) fibers, polyamide fibers such as polyamide 6 and polyamide 66, etc. can be mentioned. These may be used alone or in combination of two or more kinds. Among these, from the viewpoint of durability of the multilayered hose, at least one kind of reinforcement fiber selected from the group consisting of polyamide fibers, polyethylene terephthalate fibers, and polyvinyl alcohol fibers is preferred.

The reinforcement fiber layer may be a reinforcement fiber layer that has been subjected to dipping treatment with an adhesive. The reinforcement fiber layer subjected to dipping treatment may be a layer formed by weaving reinforcement fibers that have been subjected to dipping treatment, or may be formed by weaving reinforcement fibers and then applying dipping treatment on the reinforcement fiber layer.

The weaving method for the above reinforcement fibers is not particularly limited, and may include spiral weaving, braid weaving, or the like.

### [Method of Manufacturing Multilayered Hose]

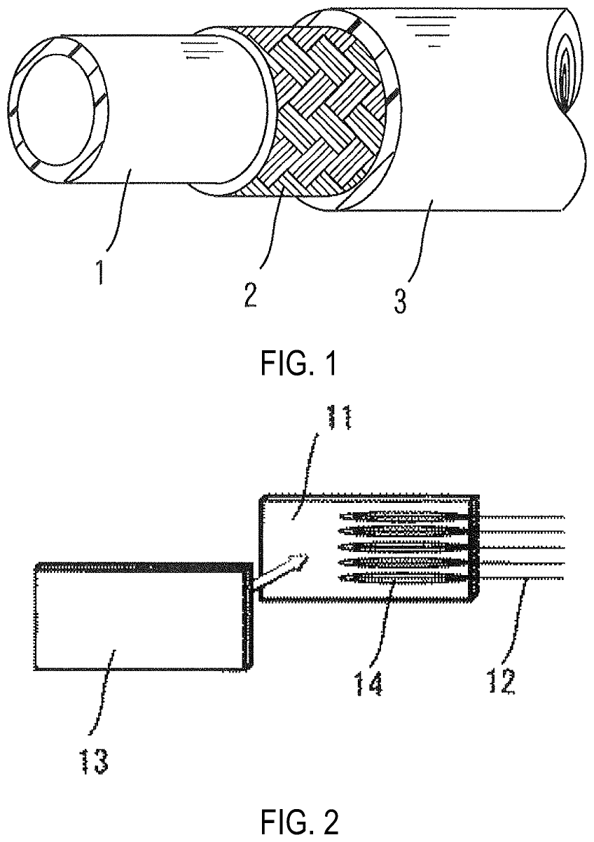

An example of the manufacturing method of a multilayered hose using the rubber composition will be described with reference to FIG. 1.

First, the above components (A) to (D) and, if necessary, other components are formulated, and these are kneaded using a kneading machine such as a roll, a kneader, and a Banbury mixer to prepare the rubber composition. Then, after extrusion molding the rubber composition into a hose shape, a reinforcement fiber layer 2 is formed by, for example, spirally winding reinforcement fibers around the outer peripheral surface of the extrusion molded product. Subsequently, the rubber composition is extrusion molded on the outer peripheral surface of the reinforcement fiber layer 2, and the resulting hose-shaped laminate is heated under predetermined conditions so as to obtain a multilayered hose with a 3-layer structure (inner-side rubber layer 1/reinforcement fiber layer 2/outer-side rubber layer 3) (see FIG. 1) in which the reinforcement fiber layer 2 is integrally formed on the outer peripheral surface of the inner-side rubber layer 1, and an outer-side rubber layer 3 is integrally formed on the outer peripheral surface of the reinforcement fiber layer 2.

Since the interlayer adhesion between the rubber layers (inner-side rubber layer 1, outer-side rubber layer 3) composed of the rubber composition and the reinforcement fiber layer 2 is high, the lamination as described above can be performed without applying an adhesive (adhesive-less), but an adhesive may be used if necessary.

The dimensions of the multilayered hose obtained in this manner are not particularly limited, but the outer diameter of the multilayered hose is typically about 8 mm to 50 mm, and the total thickness (hose wall thickness) of the multilayered hose is typically about 1.8 mm to 6 mm. In addition, the thickness of each layer constituting the multilayered hose is not particularly limited as long as the thickness is within a range where the intended function of each layer can be sufficiently achieved, but for example, the thickness of the inner-side rubber layer 1 is typically about 1 mm to 4 mm, and the thickness of the outer-side rubber layer 3 is typically about 0.8 mm to 2 mm.

In an embodiment of the disclosure, it is not necessarily required to constitute both the inner-side rubber layer 1 and the outer-side rubber layer 3 with rubber layers formed using a rubber composition containing the above components (A) to (D), and it is possible to make either one of the inner-side rubber layer 1 and the outer-side rubber layer 3 a general-purpose rubber layer formed using a general-purpose rubber material.

In the case of forming a general-purpose rubber layer composed of a composition other than the rubber composition, the material is not particularly limited, but for example, component (A), chloroprene rubber (CR), styrene butadiene rubber (SBR), acrylic rubber (ACM), ethylene acrylate rubber (AEM), chlorinated polyethylene (CM), chlorosulfonated polyethylene (CSM), etc. can be mentioned. Acrylonitrile butadiene rubber (NBR), hydrogenated acrylonitrile butadiene rubber (HNBR), acrylic rubber (ACM), ethylene acrylate rubber (AEM), chlorinated polyethylene (CM), chlorosulfonated polyethylene (CSM), fluorine rubber (FKM), etc. may also be used. These may be used alone or in combination of two or more kinds. In addition, additives such as filler and plasticizer may be appropriately formulated in the rubber layer as needed.

An exemplary embodiment of the disclosure is an embodiment in which one of the inner-side rubber layer 1 and the outer-side rubber layer 3 is a rubber layer formed using a rubber composition including the above components (A) to (D), and the other of the inner-side rubber layer 1 and the outer-side rubber layer 3 is a rubber layer formed using a rubber composition including the above components (A) and (D), and more preferably, an embodiment in which both the inner-side rubber layer 1 and the outer-side rubber layer 3 are rubber layers formed using the rubber composition including the above components (A) to (D).

In addition, the multilayered hose according to an embodiment of the disclosure is not limited to the 3-layer structure (inner-side rubber layer 1/reinforcement fiber layer 2/outer-side rubber layer 3) as shown in FIG. 1, and is not particularly limited as long as the multilayered hose has a structure of two or more layers that has a multilayered structure of a rubber layer composed of the rubber composition and other layers (for example, reinforcement fiber layer, etc.).

For example, in a multilayered hose including a multilayered structure of “resin layer (innermost layer)/rubber layer”, a multilayered hose in which the rubber layer is a rubber layer composed of the rubber composition; or in a multilayered hose having a 4-layer structure of “resin layer (innermost layer)/inner-side rubber layer/reinforcement layer (for example, a reinforcement layer composed of metal wire, etc.)/outer-side rubber layer”, a multilayered hose in which the inner-side rubber layer and/or the outer-side rubber layer is a rubber layer composed of the rubber composition can be mentioned.

In addition, preferred specific examples of the layer structure in the multilayered hose according to an embodiment of the disclosure include, but are not limited to, the following: specifically, in a multilayered hose including a 3-layer structure of “inner-side rubber layer/reinforcement fiber layer/outer-side rubber layer”, a multilayered hose in which the inner-side rubber layer and/or the outer-side rubber layer is a rubber layer composed of the rubber composition; and for example, in a multilayered hose including a 4-layer structure of “inner-side rubber layer/intermediate rubber layer/reinforcement fiber layer/outer-side rubber layer”, a multilayered hose in which the intermediate rubber layer and/or the outer-side rubber layer is a rubber layer composed of the rubber composition.

In addition, for example, in a multilayered hose including a 5-layer structure of “inner-side rubber layer/reinforcement fiber layer/intermediate rubber layer/reinforcement fiber layer/outer-side rubber layer”, a multilayered hose in which some layers (one or two layers) or all layers of the inner-side rubber layer, the intermediate rubber layer, and the outer-side rubber layer are rubber layers composed of the rubber composition.

The application of the multilayered hose according to an embodiment of the disclosure is not particularly limited, but can be suitably used as motor vehicle hoses such as a radiator hose used for connection between an engine and a radiator in vehicles such as a motor vehicle, an engine cooling system hose such as a heater hose used for connection between an engine and a heater core, a refrigerant transport hose for a cooler, a fuel cell vehicle hose such as a methanol fuel hose and a hydrogen fuel hose, and a gasoline fuel hose.

### Example

Next, examples of the disclosure will be described together with comparative examples. However, the disclosure is not limited to these examples.

First, prior to the examples and comparative examples, the following materials were prepared as components (A) to (D).

### [EPDM (Component A)]

(A-1) Esprene (registered trademark) EPDM552 (iodine value: 12, ethylene ratio: 55 mass %) manufactured by Sumitomo Chemical

### [Tackifier (Component B)]

(B-1) Petrotac (registered trademark) 90HS (aromatic monomer ratio 20 mass %, petroleum resin) manufactured by Tosoh

(B-2) Petrotac (registered trademark) 100V (aromatic monomer ratio 40 mass %, petroleum resin) manufactured by Tosoh

(B-3) Petrotac (registered trademark) 90 (aromatic monomer ratio 70 mass %, petroleum resin) manufactured by Tosoh

(B-4) Petcoal (registered trademark) LX (aromatic monomer ratio 100 mass %, petroleum resin) manufactured by Tosoh

(B-5) Nitto Resin (registered trademark) Coumarone G-90 (aromatic monomer ratio 100 mass %, coumarone resin) manufactured by Nitto Kagaku

### [Tackifier (Component B′)]

(B′-1) Arkon (registered trademark) P-90 (aromatic monomer ratio 0 mass % (aliphatic monomer ratio 100 mass %), hydrogenated petroleum resin) manufactured by Arakawa Chemical Industries

### [Bismaleimide Compound (Component C)]

(C-1) N,N′-(1,3-phenylene)bismaleimide manufactured by Tokyo Chemical Industry

### [Crosslinking Agent (Component D)]

(D-1) SULFAX (registered trademark) PS (sulfur-based crosslinking agent) manufactured by Tsurumi Chemical Industry

(D-2) Percumyl (registered trademark) D (peroxide-based crosslinking agent) manufactured by Nippon Oil & Fats

### Examples 1 to 10, Comparative Examples 1 to 8

First, components (A) to (D) were used in the proportions shown in Table 1 below, and as optional components, crosslinking accelerator 4 parts by mass, filler 155 parts by mass, zinc oxide 5 parts by mass, and plasticizer 70 parts by mass (all proportions are relative to 100 parts by mass of component (A)) were mixed to prepare rubber compositions for rubber layers.

Specifically, to component (A), components other than component (D) and crosslinking accelerator were added and mixed in a 1.7 L Banbury mixer, then component (D) and crosslinking accelerator were added and mixed in an 8-inch roll to prepare rubber compositions for rubber layers.

The crosslinking accelerator used was a combination of tetramethylthiuram disulfide, tetraethylthiuram disulfide, N-cyclohexyl-2-benzothiazolylsulfenamide, and zinc dibutyldithiocarbamate at 1 part by mass each (total 4 parts by mass). The filler used was a combination of SRF grade carbon black 120 parts by mass, talc 15 parts by mass, and clay 20 parts by mass (total 155 parts by mass). The plasticizer used was a paraffinic process oil.

The rubber compositions for rubber layers obtained in the examples and comparative examples were evaluated for properties according to the following criteria. These results are also shown in Table 1 below.

### [Interlayer Adhesion Test (Fiber-Rubber Pull-Out Test)]

An uncrosslinked rubber sheet (120 mmx 120 mm×2 mm) of each rubber composition for rubber layer was prepared respectively (rubber sheet 11 and rubber sheet 13 in FIG. 2), and as shown in FIG. 2, five reinforcement fibers 12 (manufactured by Toray, S-1400T/1HH (polyamide fiber [nylon 66])) with a total length of 300 mm were arranged on one of the rubber sheets (rubber sheet 11) (rubber contact portion was about 30 mm), the other rubber sheet (rubber sheet 13) was stacked on top, and crosslinking was performed by hot pressing at 150° C. for 30 minutes to prepare a test specimen. Then, the reinforcement fibers 12 were pulled at 50 mm/min, and the pull-out strength at the time was measured and evaluated according to the following criteria. (Evaluation criteria)
good . . . pull-out strength of 40N/fiber or more.
poor . . . pull-out strength of less than 40N/fiber.

### [Compression Set Test]

According to JIS K 6262, the rubber composition for rubber layer was crosslinked by holding the rubber composition at 150° C. for 30 minutes using a predetermined mold to prepare a circular test specimen (large test specimen) with a diameter of 29 mm and a thickness of 12.5 mm. The obtained test specimen was compressed by 25% and left still at 125° C. for 24 hours according to JIS K 6262, and the compression set (%) was measured and evaluated according to the following criteria.

### (Evaluation Criteria)

very good . . . compression set (%) of less than 65%.
good . . . compression set (%) of 65% or more and 70% or less.
poor . . . compression set (%) exceeding 70%.

TABLE 1
(Parts by mass)

| | | Example | | | | | | | | |
|---|---|---|---|---|---|---|---|---|---|---|
| | | 1 | 2 | 3 | 4 | 5 | 6 | 7 | 8 | 9 |
| A | EPDM (A) | 100 | 100 | 100 | 100 | 100 | 100 | 100 | 100 | 100 |
| B | Tackifier (B-1) | 5 | — | — | — | — | — | — | — | — |
| | [aromatic monomer ratio 20%] | | | | | | | | | |
| | Tackifier (B-2) | — | 5 | — | — | — | 5 | — | — | — |
| | [aromatic monomer ratio 40%] | | | | | | | | | |
| | Tackifier (B-3) | — | — | 5 | — | — | — | 2.5 | 7 | 2 |
| | [aromatic monomer ratio 70%] | | | | | | | | | |
| | Tackifier (B-4) | — | — | — | 5 | — | — | — | — | — |
| | [aromatic monomer ratio 100%] | | | | | | | | | |
| | Tackifier (B-5) | — | — | — | — | 5 | — | — | — | — |
| | [aromatic monomer ratio 100%] | | | | | | | | | |
| B′ | Tackifier (B′) | — | — | — | — | — | — | — | — | — |
| | [aromatic monomer ratio 0%] | | | | | | | | | |
| C | N,N′-(1,3-phenylene)bismaleimide (C) | 5 | 5 | 5 | 5 | 5 | 5 | 2.5 | 7 | 8 |
| D | Sulfur-based crosslinking agent (D-1) | 1 | 1 | 1 | 1 | 1 | — | 1 | 1 | 1 |
| | Peroxide-based crosslinking agent (D-2) | — | — | — | — | — | 2.5 | — | — | — |
| | (B) + (C) [parts by mass] | 10 | 10 | 10 | 10 | 10 | 10 | 5 | 14 | 10 |
| | (B)/(C) [mass ratio] | 1 | 1 | 1 | 1 | 1 | 1 | 1 | 1 | 0.25 |
| Evaluation | Interlayer adhesion | Good | Good | Good | Good | Good | Good | Good | Good | Good |
| | Compression set property | Very | Very | Very | Very | Very | Very | Good | Good | Good |
| | | good | good | good | good | good | good | | | |

(Parts by mass)

| | | Exam- | | | | | | | | |
|---|---|---|---|---|---|---|---|---|---|---|
| | | ple | Comparative Example | | | | | | | |
| | | 10 | 1 | 2 | 3 | 4 | 5 | 6 | 7 | 8 |
| A | EPDM (A) | 100 | 100 | 100 | 100 | 100 | 100 | 400 | 100 | 100 |
| B | Tackifier (B-1) | — | — | — | — | 5 | — | — | — | — |
| | [aromatic monomer ratio 20%] | | | | | | | | | |
| | Tackifier (B-2) | — | — | — | — | — | 5 | — | — | — |
| | [aromatic monomer ratio 40%] | | | | | | | | | |
| | Tackifier (B-3) | 6 | — | — | — | — | — | 5 | — | — |
| | [aromatic monomer ratio 70%] | | | | | | | | | |
| | Tackifier (B-4) | — | — | — | — | — | — | — | 5 | — |
| | [aromatic monomer ratio 100%] | | | | | | | | | |
| | Tackifier (B-5) | — | — | — | — | — | — | — | — | — |
| | [aromatic monomer ratio 100%] | | | | | | | | | |
| B′ | Tackifier (B′) | — | — | — | — | — | — | — | — | — |
| | [aromatic monomer ratio 0%] | | | | | | | | | |
| C | N,N′-(1,3-phenylene)bismaleimide (C) | 4 | — | — | 5 | — | — | — | — | 5 |
| D | Sulfur-based crosslinking agent (D-1) | 1 | 1 | — | 1 | 1 | 1 | 1 | 1 | 1 |
| | Peroxide-based crosslinking agent (D-2) | — | — | 2.5 | — | — | — | — | — | — |
| | (B) + (C) [parts by mass] | 10 | — | — | 5 | 5 | 5 | 5 | 5 | 5 |
| | (B)/(C) [mass ratio] | 1.5 | — | — | — | — | — | — | — | — |
| Evaluation | Interlayer adhesion | Good | Poor | Poor | Poor | Poor | Poor | Poor | Poor | Poor |
| | Compression set property | Good | Good | Very | Poor | Poor | Poor | Poor | Poor | Good |
| | | | | good | | | | | | |

The results in the above table show that in multilayer hoses using rubber compositions that do not include any of components (A) to (D), as in the comparative examples, the adhesion between the rubber layer and the reinforcement fiber layer is insufficient.

Specifically, it is shown that in cases where components (B) and (C) are not included as in Comparative Examples 1 and 2; in cases where component (B) is not included as in Comparative Examples 3 and 8; and in cases where component (C) is not included as in Comparative Examples 4 to 7, the adhesion between the rubber layer and the reinforcement fiber layer is insufficient.

On the other hand, it is shown that multilayer hoses using rubber compositions that include all components (A) to (D), as in the examples, excel in adhesion between the rubber layer and the reinforcement fiber layer.

In addition, the results in the above table show that in multilayer hoses using rubber compositions that do not include any of components (A) to (D), as in the comparative examples, interlayer adhesion and compression set property cannot be achieved simultaneously.

On the other hand, it is shown that multilayer hoses using rubber compositions that include all components (A) to (D), as in the examples, can achieve both interlayer adhesion and compression set property.

Furthermore, to verify the influence of the ratio of aromatic monomer in component (B) (ratio of the constituent unit derived from an aromatic monomer) on interlayer adhesion, cases where conditions other than the ratio of aromatic monomer in component (B) were identical were compared. Specifically, Examples 1 to 4 (ratios of 20 mass %, 40 mass %, 70 mass %, and 100 mass %) were compared with Comparative Example 3 (ratio of 0 mass %).

As a result, in the case where the result (N/fiber) of [interlayer adhesion test (fiber-rubber pull-out test)] of Comparative Example 3 was used as a reference and indexed as 100, Example 1 was 150, and Examples 2 to 4 were 175 or more. Therefore, it is shown that from the viewpoint of improving interlayer adhesion, the ratio of aromatic monomer in component (B) (ratio of the constituent unit derived from an aromatic monomer) is preferably 20 mass % or more, and particularly preferably 40 mass % or more.

Although specific embodiments of the disclosure have been shown in the above examples, the above examples are merely illustrative and should not be interpreted as limiting. Various modifications that are apparent to those skilled in the art are intended to be within the scope of the disclosure.

### INDUSTRIAL APPLICABILITY

The rubber composition for a rubber layer of the disclosure is suitable for a rubber layer of motor vehicle hoses, and for example, can be suitably used as motor vehicle hoses such as a radiator hose used for connection between an engine and a radiator in vehicles such as a motor vehicle, an engine cooling system hose such as a heater hose used for connection between an engine and a heater core, a refrigerant transport hose for a cooler, a fuel cell vehicle hose such as a methanol fuel hose and a hydrogen fuel hose, and a gasoline fuel hose. In addition, the motor vehicle hose of the disclosure can be used not only for motor vehicles but also for other transportation machines (airplanes, forklifts, shovel cars, industrial transport vehicles such as cranes, railway vehicles, etc.).

1. A rubber composition for a rubber layer of a multilayered hose, the rubber composition comprising following components (A) to (D):
(A) an ethylene-propylene-diene terpolymer,
(B) a tackifier including a constituent unit derived from an aromatic monomer,
(C) a bismaleimide compound, and
(D) a crosslinking agent.

2. The rubber composition for the rubber layer according to claim 1, wherein the component (B) is a tackifier including 20 mass % or more of a constituent unit derived from an aromatic monomer.

3. The rubber composition for the rubber layer according to claim 1, wherein the component (B) and the component (C) have a total content (B+C) of 2.5 parts by mass to 20 parts by mass with respect to 100 parts by mass of the component (A).

4. The rubber composition for the rubber layer according to claim 1, wherein the component (B) and the component (C) have a mass ratio (B/C) of 0.25 to 1.5.

5. The rubber composition for the rubber layer according to claim 1, wherein the component (C) is an aromatic bismaleimide compound.

6. The rubber composition for the rubber layer according to claim 1, wherein the component (B) is a tackifier further including a constituent unit derived from an aliphatic monomer.

7. The rubber composition for the rubber layer according to claim 1, wherein the multilayered hose is a multilayered hose comprising a multilayered structure formed by laminating a rubber layer and a resin layer.

8. The rubber composition for the rubber layer according to claim 7, wherein the resin layer is a reinforcement fiber layer comprising a reinforcement fiber including at least one selected from a group consisting of polyamide fiber, polyethylene terephthalate fiber, and polyvinyl alcohol fiber.

9. A multilayered hose, comprising a multilayered structure formed by laminating a rubber layer including a crosslinked product of the rubber composition for the rubber layer according to claim 1, and a resin layer.

10. The multilayered hose according to claim 9, wherein the resin layer is a reinforcement fiber layer.

11. A multilayered hose for a motor vehicle, the multilayered hose comprising a multilayered structure formed by laminating, in this order, a first rubber layer including a crosslinked product of the rubber composition for the rubber layer according to claim 1, a reinforcement fiber layer, and a second rubber layer including a crosslinked product of a rubber composition for a rubber layer including the component (A) and the component (D).

12. The multilayered hose for the motor vehicle according to claim 11, wherein the second rubber layer is a rubber layer including a crosslinked product of a rubber composition for a rubber layer further including the component (B) and/or the component (C).
